(19) United States
(12) Patent Application Publication
(10) Pub. No.: US 2003/0035980 A1
(43) Pub. Date: Feb. 20, 2003

(54) Magnetic recording medium

(76) Inventors: Takahiro Igari, Miyagi (JP); Hiroshi Uchiyama, Miyagi (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/137,003

(22) Filed: May 2, 2002

(30) Foreign Application Priority Data
May 9, 2001 (JP) P2001-138347

(51) Int. Cl. G11B 5/738

(52) U.S. Cl. 428/694 TS

(57) ABSTRACT

An in-plane magnetic recording medium includes a resin substrate and an underlayer, the resin substrate formed without requiring a complex manufacturing process and having an optimum surface smoothness. The underlayer provides a satisfactory in-plane orientation property to a magnetic film, whereby high coercive force and high S/N ratio are provided in the magnetic recording medium, thus making the magnetic recording medium suitable for high density recording. The in-plane magnetic recording medium includes at least a substrate made of resin, an underlayer made of an alloy of Ti and tungsten W, an intermediate layer having a hexagonal close-packed structure, a magnetic film mainly composed of Co, a protecting film and a lubricant coat, successively provided one on another. The underlayer is made of an alloy of Ti containing W between 25 and 60 atomic percent, and the thickness thereof falls within 5 nm and 25 nm. Further, the intermediate layer is made of Ru, and the thickness thereof falls within 15 nm and 45 nm.

### CROSS REFERENCE TO RELATED APPLICATIONS

This application claims priority to Japanese Patent Application No. JP 2001-138347, filed on May 9, 2001, the disclosure of such application being herein incorporated by reference to the extent permitted by law.

### BACKGROUND OF THE INVENTION

1. Field of the Invention

The present invention relates to a high density in-plane magnetic recording medium for use in a hard disk drive or the like, having a magnetic film formed on a substrate thereof.

2. Related Art

A hard disk drive has been conventionally utilized as a storage unit of computers. The hard disk drive employs a magnetic disc as a recording medium. The magnetic disc may be constituted by a disc substrate made of aluminum, glass or the like, with a surface ground (or polished) at high accuracy, and a signal recording layer formed on the disc substrate. A floating slider having a magnetic head mounted thereon is provided with a predetermined floating clearance or gap over an area of the signal recording layer of the magnetic disc, whereby a signal is written into and/or read from the magnetic disc.

Since the hard disk drive has a large amount of memory capacity and being able to handle high rate data transmission, it is expected that hard disk drives be utilized not only as storage (memory) units for computers but also largely used in the audio-video (AV) market by replacing conventional video tape recorders (VTR's) for household purposes, etc.

On the other hand, as prices of computers tend to decrease, the price of the hard disk drive consequently has been strongly requested to be reduced. Furthermore, when audio-video equipment employing hard disk drives are to be widely spread in the AV market, it is also an important factor to have the hard disk drives available at low price.

In order to respond to such requests, a method in which a substrate of the magnetic disc is formed of a resin substrate of lower price as compared to conventional aluminum substrates and that can be easily manufactured has been developed.

As described above, a slider having a magnetic head mounted thereon floats above the surface of the magnetic disc having a gap or clearance of approximately 20 nm so as to write and/or read information signal. For this reason, if there is a projection having height of 20 nm or more on the surface of the magnetic disc, the magnetic head may be damaged, causing a so-called head crash.

In order to avoid such problems, when the magnetic disc with an aluminum substrate is manufactured in a conventional manner, the following manufacturing method is introduced for obtaining a smooth disc surface without any significant projection that could cause the above-described problems. That is, initially, an aluminum plate having a desired substrate shape is cut out from a base material of aluminum. Then the aluminum substrate is repeatedly subjected to a highly accurate surface treatment such as one including a grinding process and washing process. Thus a substrate having a smooth disc surface may be obtained. When the substrate is subjected to surface treatment, abrasive grain is gradually replaced by other grains having relatively smaller size as the grinding process proceeds. Thus, a projection of a height exceeding 20 nm, which may cause the head crash, is thoroughly removed from the substrate surface. Since involving the complex processes as described above, the conventional process of manufacturing the aluminum substrate is very costly.

Conversely, when a magnetic disc with a resin disc substrate (substrate made of resin) is manufactured by means of a resin injection mold or the like, the coarseness of the substrate surface corresponds to the coarseness of the surface of a stamper utilized in the forming process. For this reason, if a stamper having a highly smooth surface is utilized, the manufactured disc will have a surface of low coarseness. Thus, the grinding or polishing process or the washing process will not be required. In this way, if a resin substrate is employed, the complex manufacturing processes can be omitted, thus permitting reducing the production cost of the substrate.

In recent days, a hard disk drive has been widely utilized in the field of audio-video applications. Further, when the hard disk drive is employed in a personal computer, image data is processed, moving pictures are edited, so that the hard disk drive is required to handle an increasingly greater amount of data. For this reason, there is a trend in which there is requirement for magnetic discs to have a recording density of 10 Gb/inch² or more. In order to achieving such high recording density, it is necessary to pay an effort to decrease the noise and improve the S/N (signal to noise) ratio of the magnetic recording medium.

In general, when a recording film is formed on the aforesaid aluminum substrate or the glass substrate, the underlayer and the magnetic layer are formed by using a film forming means such as sputtering while the substrate is kept at a temperature of 200° C. or more. In a conventional manner, a chromium (Cr) film or a film of alloy mainly composed of chromium (Cr) is utilized as the underlayer. When these materials are formed into a film on the heated substrate, the chromium crystal may be easily oriented to an orientation of (200). For this reason, if a magnetic film of the cobalt (Co) group is formed directly over the underlayer, it is possible to obtain a (110) surface of cobalt crystal having lattice constant substantially equivalent to the surface of chromium crystal (200). In other words, when a material of chromium alloy material group is employed as the underlayer, it is possible to obtain an in-plane magnetic recording film having a c-axis, which is an axis of easy magnetization of cobalt, oriented in a direction within the plane of the film.

However, if the disc substrate is made of plastic (resin) having relatively low softening point, a film cannot be formed on the substrate by the above-described film forming means because the substrate cannot endure a required heating. For this reason, if a chromium (Cr) film or a film of alloy mainly composed of chromium (Cr) is formed as an underlayer on the resin substrate, it is difficult to form a Cr crystal having a desired (200) orientation, and hence a satisfactory in-plane magnetic characteristic cannot be obtained in the magnetic film.

On the other hand, if the underlayer is made of ruthenium (Ru), Ru has a hexagonal close-packed structure similar to the structure of crystal of cobalt, which is utilized as a main component of the magnetic film. Therefore, if Ru is employed as the underlayer and the obtained structure is one in which the c-axis is oriented within the plane, or more desirably, the c-axis is oriented in the (100) orientation or (101) orientation, then the in-plane orientation property of the magnetic disc can be improved more than in the case where the underlayer is formed of a Cr film or a film of alloy mainly composed of Cr. Accordingly, satisfactory magnetic characteristic and read/write characteristics can be obtained.

However, if Ru forming the hexagonal close-packed structure is formed into a film on the resin substrate as the underlayer, a plane of (002) orientation having a low energy level is grown with priority. If a magnetic film is grown on the Ru underlayer having the above-described orientation plane, a drawback is brought about that the (002) plane is also grown in the magnetic film. As a consequence, the magnetic film fails to have the in-plane magnetic characteristic.

### SUMMARY OF THE INVENTION

The present invention has been conceived in view of the above problems existing in the related art and it is preferable according to a preferred embodiment of the present invention to provide an in-plane magnetic recording medium employing a resin substrate and an underlayer in which the resin substrate can be easily formed without requiring a complicated manufacturing process and having an optimum surface smoothness. By providing an underlayer that promotes an in-plane orientation for a magnetic film to be formed thereon, properties of high coercive force and high S/N ratio may be provided in the magnetic recording medium, thus making the magnetic recording medium suitable for high density recording.

The inventors have made efforts for evaluation and considerations on the matter and propose a way of alleviating the existing problems. That is, when a magnetic film is formed on a built-up film (intermediate layer) composed of Ru on the resin-made substrate, an alloy film (Ti—W alloy) composed of titanium (Ti) and tungsten (W) is provided beneath the Ru-made intermediate layer having the hexagonal close-packed structure. Thus, the Ru crystal can be prevented from being oriented in the (002) direction on the resin substrate and the c-axis of the Ru crystal can be oriented in an in-plane direction of the layer.

That is, according to a preferred embodiment of the present invention, there is provided an in-plane magnetic recording medium at least comprised- of a substrate made of a resin, an underlayer made of an alloy of titanium (Ti) and tungsten (W) (Ti—W alloy), an intermediate layer having a hexagonal close-packed structure, a magnetic film mainly composed of cobalt (Co), a protecting film, and lubricant film successively provided one on another.

According to the above arrangement of the in-plane magnetic recording medium, an improved property of in-plane orientation is provided in the magnetic film, leading to a high coercive force and a high S/N ratio. As a result, it becomes possible to provide an in-plane magnetic recording medium having satisfactory magnetic characteristic and read/write characteristics.

According to another aspect of the present invention, there is provided an in-plane magnetic recording medium having the underlayer made of an alloy of titanium (Ti) and tungsten (W) in which the titanium contains tungsten in a range from 25 atomic percent to 60 atomic percent. According to this arrangement, a high coercive force and a high S/N ratio can be obtained.

According to another aspect of the present invention, there is provided an in-plane magnetic recording medium, the thickness of the underlayer falling within a range from 5 nm to 25 nm. According to this arrangement, a high coercive force and a high S/N ratio can be also obtained.

According to another aspect of the present invention, there is provided an in-plane magnetic recording medium, the intermediate layer made of ruthenium (Ru). According to this arrangement, a high coercive force and a high S/N ratio can also be obtained.

According to still another aspect of the present invention, there is provided an in-plane magnetic recording medium, the thickness of the intermediate layer falls in a range of from 15 nm to 45 nm. According to this arrangement, a high coercive force and a high S/N ratio can be also obtained.

If the underlayer is formed of chromium (Cr), chromium-molybdenum (Cr—Mo) alloy, chromium-titanium (Cr—Ti) alloy, or chromium-tungsten (Cr—W) alloy, which are generally utilized as the materials for the underlayer, then the crystal of the Ru intermediate layer formed on the underlayer exhibits a local peak of orientation in the (002) direction, as shown in an X-ray diffraction pattern as shown in FIG. 1. When the crystal of the Ru intermediate layer is oriented in this manner, the magnetic film provided on the Ru intermediate layer will not have a desired in-plane orientation, and hence the magnetic film fails to have a required in-plane magnetic anisotropy.

Conversely, if the underlayer is formed of titanium-tungsten (Ti—W) alloy, then the crystal of the Ru intermediate layer formed on the underlayer exhibits local peaks of orientation in the (100) direction or (101) direction, as shown in an X-ray diffraction pattern as shown FIG. 2. In this way, owing to the desirable orientation of the underlayer formed of Ti—W alloy, the c-axis of the Ru crystal can be oriented in the in-plane direction of the layer. Then the magnetic film mainly composed of Co and successively formed on the Ru intermediate layer can be satisfactorily oriented in the in-plane direction of the film. Thus it becomes possible to obtain a magnetic recording medium having optimum in-plane magnetic characteristic and read/write characteristics.

### BRIEF DESCRIPTION OF THE DRAWINGS

The above and other objects, features and advantages of the present invention will become more apparent to those skilled in the art from the following description of the presently preferred exemplary embodiments of the invention taken in conjunction with the accompanying drawings, in which:

FIG. 1 is a diagram illustrating an X-ray diffraction pattern of a ruthenium (Ru) intermediate layer when the intermediate layer is formed on an underlayer composed of chromium-tungsten (Cr—W) alloy;

FIG. 2 is a diagram illustrating an X-ray diffraction pattern of a ruthenium (Ru) intermediate layer when the intermediate layer is formed on an underlayer composed of titanium-tungsten (Ti—W) alloy;

FIG. 3 is a schematic cross-sectional view of a magnetic disc according to a preferred embodiment of the present invention;

FIG. 4 is a schematic diagram showing a cross-sectional view of a main portion of a die assembly of an injection molding apparatus according to a preferred embodiment of the present invention;

FIG. 5 is a diagram illustrative of a relationship between the thickness of a titanium-tungsten (Ti—W) alloy underlayer and a coercive force (Hc) thereof;

FIG. 6 is a diagram illustrative of a relationship between the thickness of the titanium-tungsten (Ti—W) alloy underlayer and an S/N ratio thereof;

FIG. 7 is a diagram illustrative of a relationship between the composition of tungsten contained in the underlayer and a coercive force (Hc) thereof;

FIG. 8 is a diagram illustrative of a relationship between the composition of tungsten contained in the underlayer and an S/N ratio thereof;

FIG. 9 is a diagram illustrative of a relationship between the thickness of a ruthenium (Ru) intermediate layer and a coercive force (Hc) thereof; and

FIG. 10 is a diagram illustrative of a relationship between the thickness of the ruthenium (Ru) intermediate layer and an S/N ratio thereof.

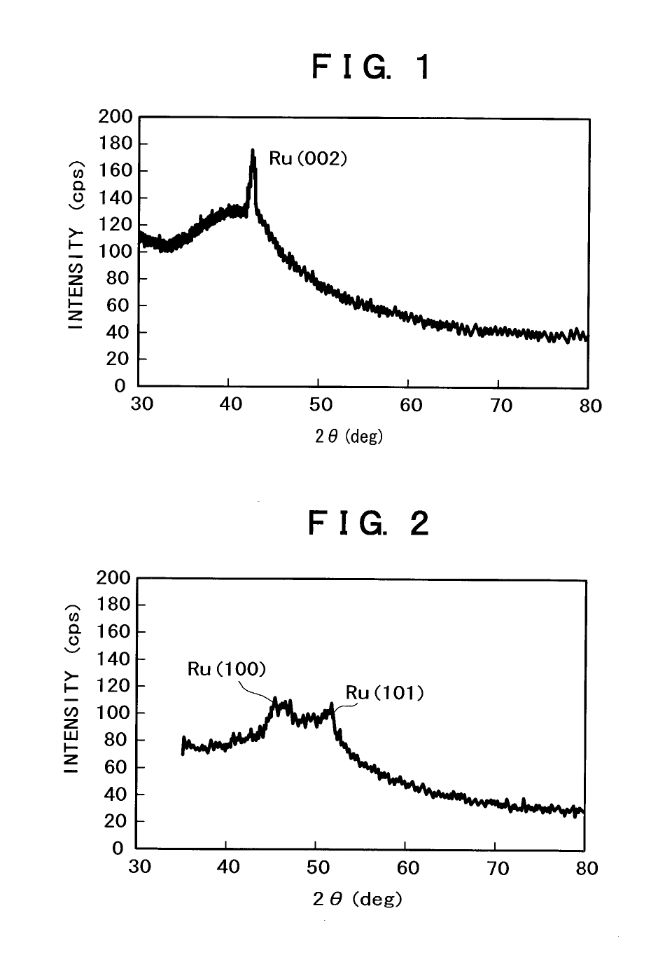

### DESCRIPTION OF PREFERRED EMBODIMENTS OF THE INVENTION

Preferred embodiments of the present invention will be hereinafter described with reference to the drawings.

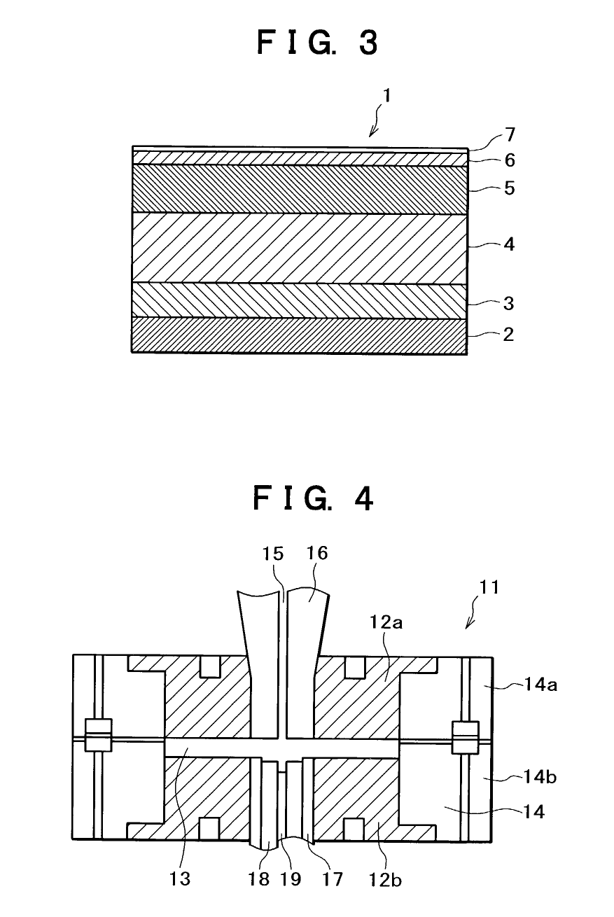

FIG. 3 is a schematic view of a magnified cross-sectional view of a main portion of a magnetic disc to which the present invention is applied. A magnetic disc 1 shown in FIG. 3 is one utilized for an in-plane magnetic recording medium of a hard disk drive. As shown in FIG. 3, the magnetic disc 1 is composed of a resin substrate 2 made of a resin material molded to have a disc-shape. Further, the magnetic disc 1 is composed of an underlayer 3, an intermediate layer 4, a magnetic film 5, a protecting film 6 and a lubricant coat 7 deposited on one another in this order on the resin substrate 2. The magnetic disc 1 is rotated by a spindle motor or the like. A slider having a magnetic head mounted thereon is provided above the surface of the magnetic disc 1 at a predetermined gap or clearance. Thus electromagnetic interaction is effected between the magnetic disc 1 and the magnetic head, whereby a signal can be written into the magnetic film 5 or a signal written in the magnetic film 5 can be read from the same.

A thermoplastic resin is suitable as the resin material forming the resin substrate 2. For example, resin materials such as polymethyl methacrylate, polycarbonate, polycycloolefin are suitable for the material of the resin disk 2. Such kinds of resin materials are suitably selected as the thermoplastic resin because these materials make it possible to form the disc substrate by injection molding or the like. The resin substrate molded by the injection molding or the like has optimum molding property, dimension stability, surface smoothness and so on. Furthermore, such a resin material will have an optimum mechanical characteristic, physical characteristic, thermal characteristic, environment-endurance characteristic and so on, which are required for a magnetic disc.

The resin substrate 2 is formed to have a disc shape, by means of injection molding or the like. It is desirable that the resin substrate 2 has formed on a surface thereof, pre-embossed patterns indicating a servo signal or the like. The pre-embossed patterns can be formed by using a stamper or a die having a reverse pattern of the pre-embossed patterns when the resin substrate 2 is formed by the injection mold.

It is preferable for the pre-embossed patterns created on the resin substrate 2 to include a projection having height of 20 nm or less. In this way, if the surface smoothness is satisfactorily provided on the resin substrate 2, then a magnetic head can be brought in close proximity to the magnetic disc 1 without risk of contact or collision between the magnetic disc and the magnetic head, and hence recording and reproduction of a signal can be realized with stability.

The underlayer 3 is formed of a Ti—W alloy film. The underlayer 3 is provided so that the intermediate layer 4 made of Ru formed on the underlayer 3 can have a desired crystalline orientation, i.e., the c-axis of the Ru crystal is in-plane oriented.

If the underlayer 3 made of Ti—W alloy film is formed, then the Ru intermediate layer 4 formed on the underlayer 3 comes to have an (100) orientation or (101) orientation, as shown, for example, in FIG. 2. This orientation will be matched with the in-plane orientation of the c-axis, or the easy-axis of Cobalt (Co), which is the main component of the magnetic film 5, provided on the intermediate film 4. For this reason, improvement is achieved in the in-plane orientation of the magnetic film 5, leading to satisfactory characteristic of the magnetic disc. If the Ru film is formed immediately on the resin substrate 2, as has been set forth above, orientation of (002) direction is grown having priority.

A preferable composition of the Ti—W alloy underlayer 3 is such that the composition of W relative to Ti falls in a range from 25 atomic percent or higher to 60 atomic percent or lower. The reason why this composition is preferable is as follows. If the composition of W relative to Ti does not reach 25 atomic percent, then the coercive force Hc and S/N ratio of the magnetic material are highly decreased. Conversely, if the composition of W relative to Ti exceeds 60 atomic percent, then the coercive force Hc and S/N ratio of the magnetic material also tend decrease.

A preferable thickness of the Ti—W alloy underlayer 3 is such that the thickness of the underlayer falls in a range from 5 nm or more to 25 nm or below. The reason why this thickness range is preferable is as follows. If the thickness does not reach 5 nm, then the coercive force Hc and S/N ratio of the magnetic material are greatly decreased. Conversely, if the thickness thereof exceeds 25 nm, then decrease of the coercive force Hc and S/N ratio of the magnetic material also observed.

It is preferable that the intermediate layer 4 be made of ruthenium (Ru). The crystalline structure of ruthenium is an hexagonal close-packed structure, which is identical to that of Co as a main component of the magnetic film 5 to be provided on the intermediate film 4. The a-axis and c-axis of the ruthenium crystal are substantially the same as those of cobalt crystal, except for a small difference of approximately 8% and 5%, respectively. For this reason, if the intermediate layer 4 has a structure in which the c-axis of the Ru crystal is in-plane oriented owing to the underlayer 3 made of Ti—W alloy film, then the magnetic film 5 is also improved in its in-plane orientation on the easy-axis. Accordingly, the magnetic film 5 comes to have an improved magnetic characteristic and improved read/write characteristics.

A preferable thickness of the intermediate film 4 is such that the thickness of the intermediate film 4 is within a range of 15 nm or more to 45 nm or below. The reason why this thickness range is preferable is as follows. That is, if the thickness does not reach 15 nm, then the coercive force Hc and S/N ratio of the magnetic material are greatly decreased. Conversely, if the thickness thereof exceeds 45 nm, then the coercive force Hc and S/N ratio of the magnetic material is also decreased.

The magnetic film 5 is made of a magnetic layer mainly composed of Co. The magnetic layer can be fabricated, for example, in a manner of sputtering or the like by using a target made of a cobalt-platinum-chromium (Co—Pt—Cr) alloy added with silicon oxide.

If the magnetic layer 5 has the above composition, the magnetic layer 5 has a structure (granular structure) in which Si oxide material is dispersed among grains of Co—Pt—Cr forming the magnetic layer 5 so that each Si oxide material mass is isolated from one another. In this way, noise caused from scattering of magnetization in a magnetic transition portion may be decreased. Moreover, since the grains may have rotation of magnetization of rotational type at once as each of the grains become magnetically isolated from one another, the coercive force thereof becomes larger. That is, the magnetic disc 1 can be made as a magnetic recording medium having a high S/N ratio and high coercive force.

The protecting film 6 is provided for protecting the magnetic disc 1 from wear, damage or the like caused by the contact with the magnetic head. For this reason, the protecting film 6 is made of a thin film mainly composed of carbon (C) having high hardness, for example.

A lubricant coat 7 is formed on the protecting film 6. Owing to the lubricant coat 7, the friction coefficient of the surface of the magnetic disc 1 can be reduced, thus the magnetic disc 1 can be smoothly rotated and having improved durability. A lubricant of parfluoroether group can be selected for example as the lubricant coat 7.

How the resin substrate 2 is formed (molded) by using an example of an injection molding apparatus will be hereinafter described with reference to FIG. 4, which illustrates a cross-sectional view of a main portion of a die assembly for the injection molding apparatus. As shown in FIG. 4, a die assembly 11 includes a fixed die 12a for forming a main surface of the disc substrate, a movable die 12b disposed on the opposite side of the fixed die 12a and forming the other main surface of the disc substrate 2, and a peripheral die assembly 14 for forming the peripheral side surface of the disc substrate 2.

The movable die 12b is supported by a guiding means not shown. The movable die 12b can be brought toward the fixed die 12a or brought apart from the same by a driving mechanism. The peripheral die assembly 14 includes a fixed side peripheral die 14a for fixing the fixed die 12a within the injection molding apparatus, and a movable side peripheral die 14b for fixing the movable die 12b within the injection molding apparatus. The peripheral side surface of the disc substrate is formed by the peripheral die assembly 14. The components of the die assembly 11, i.e., the fixed die 12a, the movable die 12b, the fixed side peripheral die 14a, and the movable side peripheral die 14b are cooperatively form a cavity 13 forming the disc substrate when these components are assembled together.

On the side of the fixed die 12a, there is provided a sprue bush 16 having a nozzle 15, and melted resin material is injected into the cavity 13 forming the shape of the disc substrate. The melted resin material is injected into the cavity 13 through the nozzle 15 at a high pressure, whereby the cavity is filled with the resin material.

On the other hand, the movable die 12b has a first ejector member 17 provided at a position corresponding to the center of the cavity so that the ejector member 17 can be freely moved in the axial direction of the die assembly 11. The first ejector member 17 has a cylindrical shape of which external diameter corresponds to a size of internal side region of the formed disc substrate on which there is no information signal recorded. When the disc substrate is taken out from the die assembly 11, the first ejector member 17 is projected out within the cavity by driving means not shown so that the formed disc substrate can be projected and removed from the movable die 12b.

The first ejector member 17 has a punch 18 attached on its inner side so that the punch can make an aperture at the center of the disc substrate to be formed. Similarly to the first ejector member 17, the punch 18 can be moved in an axial direction of the die assembly by a driving mechanism, not shown. The punch 18 is projected toward the cavity 13 by the driving mechanism, whereby a central aperture is made in a central cutting region of the disc substrate 2.

The punch 18 has a second ejector member 19 provided on its inner side so that the second ejector member 19 can move back and forward freely by a hydraulic mechanism. The second ejector member 19 is formed to have a resin spreader at the tip end of the member on the cavity side. Similarly to the first ejector member 17, the second ejector member 19 is provided so as to be movable in the axial direction. Therefore, the synthesized resin material injected at the nozzle of the sprue bush 16 is once injected toward the bottom portion of the resin spreader and spread in the cavity 13 so that the resin material fills the cavity 13 uniformly. After the central aperture is made at the center of the disc substrate 2 by the punch 18, the second ejector member 19 projects toward the synthesized resin material at the cut portion from the movable die 12b. Thus the movable die 12b is separated from the fixed die 12a.

The mechanical action of the above-arranged injection molding apparatus is as follows. Initially, the driving mechanism not shown is driven and the movable die 12b is brought close to the fixed die 12a, whereby the die components are assembled to complete the whole die assembly 11. Thus, the cavity 13 is formed in a closed space. Then, with the die assembly closed, melted resin material is injected toward the cavity 13 from the nozzle 15 of the sprue bush 16 so that the cavity is filled with the resin material. Although not shown, the injection molding apparatus has a temperature adjusting mechanism, and the temperature adjusting mechanism cools and temporarily keeps the synthesized resin material in a semi-melted state. Under this state, the punch 18 is projected from the central aperture of the first ejector member 17 toward the fixed die 12a so that the central aperture is formed in the formed disc substrate 2.

Thereafter, the driving mechanism of the injection molding apparatus, although not shown, is driven so that the movable die 12b is separated from the fixed die 12a. Thus, the die assembly 11 is opened. Finally, the disc substrate formed within the cavity 13 is taken out by the first ejector member 17 which is effected when the fixed die 12a and the movable die 12b are placed in the open state of the die assembly 11. In other words, the disc substrate (resin substrate) 2 is pushed from the first ejector member 17 from the movable die side and taken out by an extracting mechanism, not shown.

The resin substrate obtained by the above process is subjected to the following process in which, as shown in FIG. 3, the underlayer 3, the intermediate layer 4, the magnetic film 5, protecting film 6 and lubricant coat 7 and so on are formed in this order so as to obtain the magnetic disc 1.

### EXAMPLES OF EMBODIMENTS OF THE PRESENT INVENTION

Several specific examples of the present invention will be hereinafter described in detail based on experiments. However, it should be understood that the present invention is not limited to the following examples.

### Examples 1 to 9

Resin substrates of 3.5 inches were manufactured by the above-described injection molding method. All of the examples 1 to 9 have the same or substantially the same construction as that shown in FIG. 3, and each of the films was formed on the surface of the resin substrate by sputtering method. The apparatus for forming the films was an in-line system sputtering machine equipped with a plurality of sputter chambers so that each of the films was formed by effecting sputtering. An outline of the film forming method was as follows. Initially, the resin substrate was held by a holder device and provided within a chamber in which an achieved degree of vacuum was 6.67×10⁻⁵ Pa (5×10⁻⁷ Torr) or lower. In each of the sputter chambers prepared for effecting respective film forming processes, the resin substrate was disposed so as to oppose a target for effecting sputtering. Then an inert gas (Argon (Ar) gas) was introduced into the chamber to form the film and the resin substrate was conveyed from one chamber to another chamber successively for effecting respective film forming processes.

When the underlayer 3 of each Example 1 to 9 was formed, a target made of a Ti alloy added with W at 50 atomic percent was utilized, the resin substrate was placed in an atmosphere of Ar gas at a pressure of 0.27 Pa (2 mTorr), and DC (Direct Current) sputtering was effected so that the underlayer 3 came to have a composition of Ti at 50 atomic percent and W at 50 atomic percent (This composition is hereinafter denoted by 50Ti-50W Composition of other chemical compound will also be denoted by the similar notation in which terms of “atomic percent” are abbreviated.) Thus, various types of resin substrates each having the underlayer 3 deposited thereon were produced so that each underlayer had a thickness variable depending on each underlayer. The underlayers 3 had thickness of 3 nm, 5 nm, 8 nm, 10 nm, 13 nm, 15 nm, 20 nm, 25 nm, and 30 nm, respectively.

Throughout Examples 1 to 9, the intermediate layer 4, the magnetic film 5, the protecting film 6, the lubricant coat 7, which were successfully formed on the underlayer 3, were formed under same conditions. That is, when the intermediate layer 4 was formed, an Ru target was utilized and the resin substrate was placed in an atmosphere of Ar gas at a pressure of 11.3 Pa (85 mTorr), and DC sputtering was effected so as to obtain the intermediate film 4 having the Ru film thickness of 20 nm.

When the magnetic film 5 of each Example 1 to 9 was formed, a target made of a Co—Pt—Cr alloy added with silicon oxide at 12 atomic percent was utilized, the resin substrate was placed in an atmosphere of Ar gas at a pressure of 1.1 Pa (8 mTorr), and RF (Radio Frequency) sputtering was effected for forming the magnetic film 5 so that the product of the remanent magnetization and film thickness (remanent magnetization (Mr)×thickness of magnetic film (t)) became 0.4 memu/cm².

Thereafter, a carbon protecting film 6 having a thickness of 6 nm was formed on the magnetic film 5 and then the lubricant coat 7 was formed thereon at each final process of example. Thus the magnetic disc 1 was obtained.

### Example 10

The resin substrate of Example 10 was fabricated in a manner similar to those of Examples 1 to 9. The underlayer 3 composed of only Ti was formed on the resin substrate 2. The condition under which the underlayer was formed was as follows. That is, a target composed of Ti utilized, similarly to Example 4, the resin substrate was placed in an atmosphere of Ar gas at a pressure of 0.27 Pa (2 mTorr), and DC sputtering was effected so that an underlayer having a thickness of 10 nm was formed.

Thereafter, the intermediate layer 4, the magnetic film 5, the protecting film 6 and the lubricant coat 7 were successively formed on the underlayer 3 under conditions substantially identical to those of Examples 1 to 9. Also, the intermediate layer 4, the magnetic film 5, the protecting film 6 and the lubricant coat 7 were formed to have thickness exactly the same as those of Examples 1 to 9. Thus, a magnetic disc 1 as Example 10 was obtained.

### Examples 11 to 14

When Examples 11 to 14 were fabricated, the underlayer 3 formed of Ti—W alloy type was employed, but variation was made in the amount of W added to Ti of each example. However, except for the composition of the underlayer 3, each of Examples 11 to 14 were fabricated under substantially the same film forming conditions as that of Example 4 and each film of Example 11 to 14 was formed to have similar thickness as those of Example 4. Thus, magnetic discs 1 of the Examples 11 to 14 were fabricated, respectively. The compositions of the Ti—W alloy of the underlayer 3 were 75Ti-25W, 60Ti-40W, 40Ti-60W, 35Ti-65W, respectively.

### Example 15

The underlayer 3 formed in the magnetic disc 1 of Example 15 was composed of W only. Except for the composition of the underlayer 3, the magnetic disc 1 as Example 15 was made to have a same film arrangement as that of Example 4, and fabricated under the same film forming condition as that of Example 4. Also, the films of Example 15 were formed to have the same film thickness as those of Example 4. In this way, the magnetic disc 1 of Example 15 was obtained.

### Example 16

The underlayer 3 formed in the magnetic disc 1 of Example 16 was composed of only tantalum (Ta). Except for the composition of the underlayer 3, the magnetic disc 1 as Example 16 was made to have substantially a same film arrangement as that of Example 4, and fabricated under similar film forming conditions as that of Example 4. Also, the films of Example 16 were formed to have substantially a same film thickness as those of Example 4. In this way, the magnetic disc 1 of Example 15 was obtained.

### Example 17

The underlayer 3 formed in the magnetic disc 1 of Example 17 was composed of only molybdenum (Mo). Except for the composition of the underlayer 3, the magnetic disc 1 as Example 17 was made to have substantially a same film arrangement as that of Example 4, and fabricated under similar film forming conditions as that of Example 4. Also, the films of Example 17 were formed to have substantially the same film thickness as those of Example 4. In this way, the magnetic disc 1 of Example 15 was obtained.

### Example 18

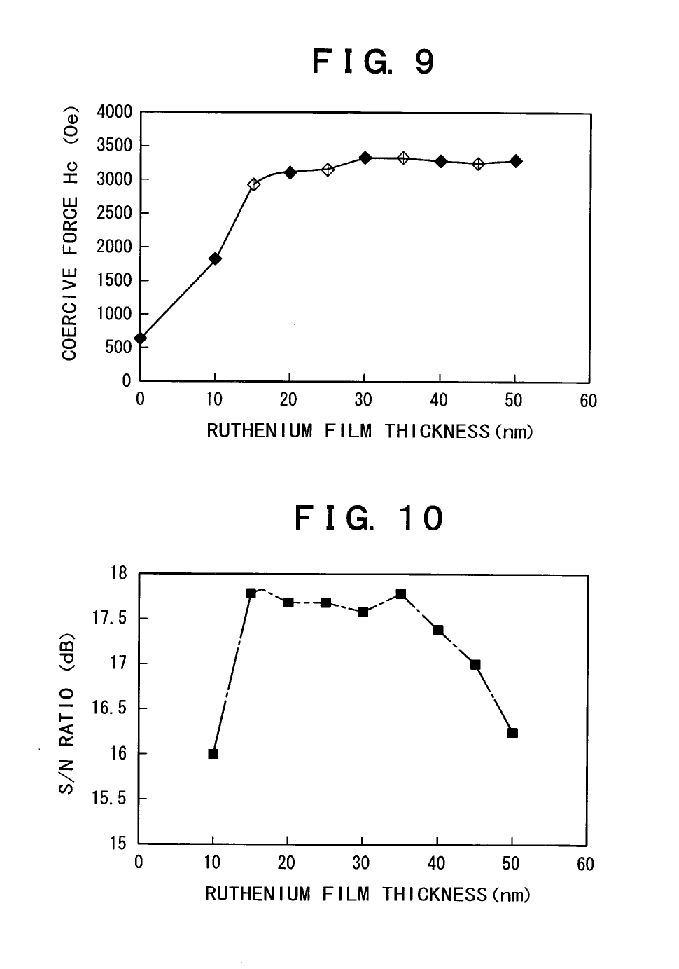

When magnetic discs 1 of Example 18 were fabricated, variation is made in the thickness of the intermediate film 4 composed of Ru with respect to Example 4. All films except for the thickness of the intermediate film 4, i.e., the underlayer 3, the magnetic film 5, the protecting film 6, the lubricant coat 7 were formed under a same condition as that of Example 4. Also, the underlayer 3, the magnetic film 5, the protecting film 6, the lubricant coat 7 were formed to have a thickness substantially the same as those of Example 4. In this way, magnetic discs 1 of Example 18 were fabricated so as to have respectively determined thickness. The thickness of the Ru intermediate layer 4 was varied in a range of from 10 nm to 50 nm. The result therefrom will be described below with reference to FIGS. 9 and 10.

### Reference Example 1

Reference Example 1 had such an arrangement that the underlayer 3 included in the arrangement shown in FIG. 3 was omitted, and other films, i.e., the intermediate layer 4, the magnetic film 5, the protecting film 6, and the lubricant coat 7 were formed on the resin substrate 2, in a similar manner of the arrangement shown in FIG. 3. In other words, the intermediate layer 4 was formed directly on the resin substrate 2. When the intermediate layer 4 was formed, an Ru target was utilized and the resin substrate was placed in an atmosphere of Ar gas at a pressure of 11.3 Pa (85 mTorr), and DC sputtering was effected so as to obtain the intermediate film 4 having the Ru film thickness of 20 nm.

When the magnetic film 5 of the Reference Example 1 was formed, similarly to the aforesaid Examples 1 to 17, a target made of a Co—Pt—Cr alloy added with silicon oxide at 12 atomic percent was utilized, the resin substrate was placed in an atmosphere of Ar gas at a pressure of 1.1 Pa (8 mTorr), and RF sputtering was effected for forming a film so that a product of the remanent magnetization and film thickness (remanent magnetization (Mr)×thickness of magnetic film (t)) became 0.4 memu/cm².

Thereafter, a carbon protecting film 6 having a thickness of 6 nm was formed on the magnetic film 5 and then the lubricant coat 7 was provided thereon so as to obtain the magnetic disc 1.

### Reference Example 2

A commercially available magnetic disc (glass disc) made of glass having a recording capacity of 14 Gb/inch² was prepared as Reference Example 2.

The magnetic discs obtained as Examples 1 to 18 and Reference Examples 1 and 2 were brought to a step of evaluation for evaluating the magnetic characteristics and read/write characteristics of each magnetic disc. The magnetic characteristic was measured in such a manner that the fabricated magnetic disc was partly cut to prepare a specimen of the magnetic disc material having a size of 1 cm², and this specimen was placed under measurement of a vibrating sample magnetometer (VSM). The S/N ratio was measured in such a manner that the magnetic disc was placed on a spin stand rotating at a disk rotating speed of 5400 rpm, the measuring diameter was set to 28.7 mm, a signal having a recording frequency of 67.9 MHz was recorded, and then a ratio of an output signal amplitude (Peak-to-Peak value) to noise (integrated value of noise spectrum in a range of from 0.5 MHz to 150 MHz, rms value) was determined as the S/N ratio. The magnetic head employed for the measurement was a Merge type GMR head having write track width was 0.7 μm and read track width was 0.5 μm.

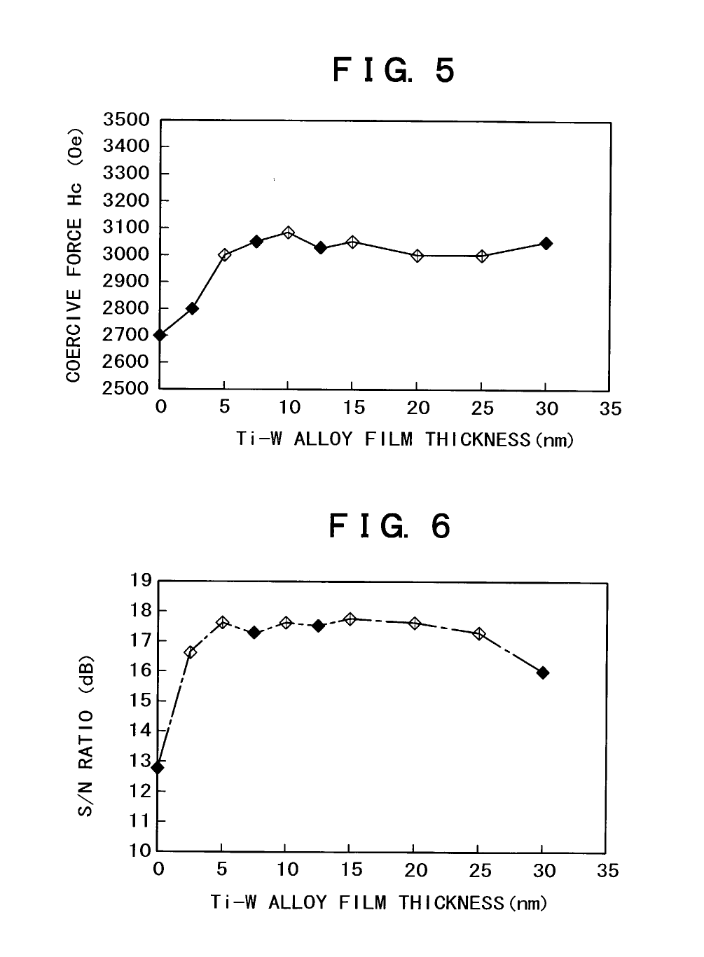

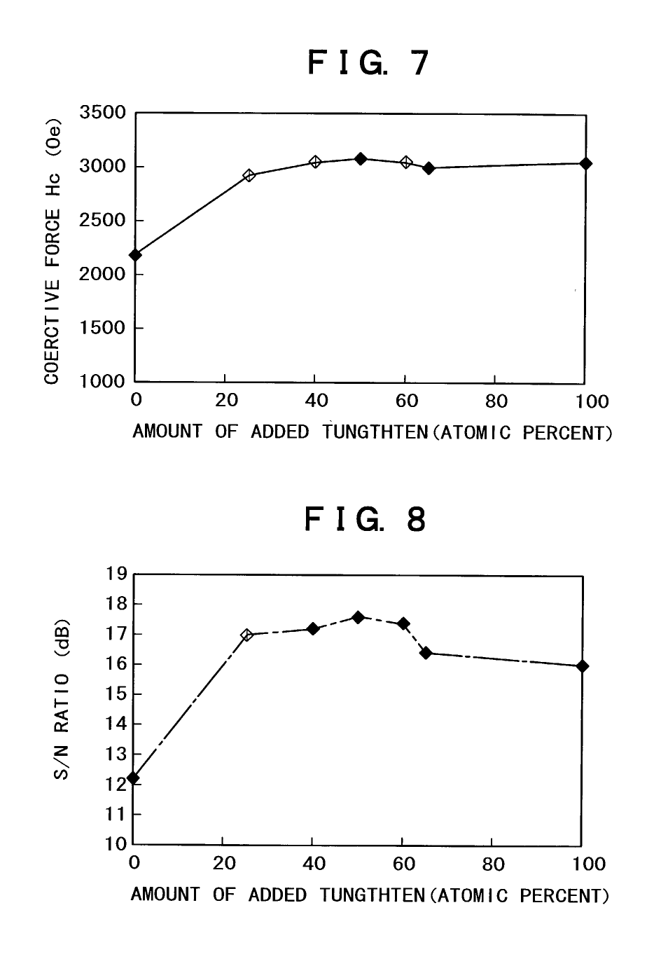

A result of evaluation regarding Examples 1 to 17 and Reference Examples 1 and 2 are shown in Table 1. FIG. 5 is a diagram illustrating a relationship between the thickness of the Ti—W alloy underlayer 3 and the coercive force Hc thereof. FIG. 6 is a diagram illustrative of a relationship between the thickness of the Ti—W alloy underlayer 3 and the S/N ratio thereof. FIG. 7 is a diagram illustrative of a relationship between the composition of W contained in the underlayer 3 (amount of tungsten added to the alloy) and the coercive force Hc thereof. FIG. 8 is a diagram illustrative of a relationship between the composition of tungsten contained in the underlayer 3 (amount of tungsten added to the alloy) and the S/N ratio thereof. FIGS. 9 and 10 illustrate the result of evaluation on magnetic discs of Example 18. That is, FIG. 9 is a diagram illustrative of a relationship between the thickness of the Ru (ruthenium) intermediate layer 4 and the coercive force Hc thereof, and FIG. 10 is a diagram illustrative of a relationship between the thickness of the Ru (ruthenium) intermediate layer 4 and the S/N ratio thereof. While in the diagrams the coercive force notation is made under the unit of Oe, this specification also presents a unit representation in terms of a unit (A/m) according to the SI. Conversion of units is made by an equation 1 Oe [symbol] 79 A/m.

TABLE 1

| Number of | Composition | Thickness | Coercive | |
|---|---|---|---|---|
| the | of | of | force Hc | S/N ratio |
| example | underlayer | underlayer | [Oe] | [dB] |
| Example 1 | 50Ti-50W | 3 nm | 2800 | 16.7 |
| Example 2 | 50Ti-50W | 5 nm | 3000 | 17.7 |
| Example 3 | 50Ti-50W | 8 nm | 3050 | 17.4 |
| Example 4 | 50Ti-50W | 10 nm | 3090 | 17.7 |
| Example 5 | 50Ti-50W | 13 nm | 3020 | 17.6 |
| Example 6 | 50Ti-50W | 15 nm | 3050 | 17.8 |
| Example 7 | 50Ti-50W | 20 nm | 3000 | 17.7 |
| Example 8 | 50Ti-50W | 25 nm | 3000 | 17.4 |
| Example 9 | 50Ti-50W | 30 nm | 3060 | 16.0 |
| Example 10 | Ti | 10 nm | 2200 | 12.2 |
| Example 11 | 75Ti-25W | 10 nm | 2980 | 17.0 |
| Example 12 | 60Ti-40W | 10 nm | 3040 | 17.2 |
| Example 13 | 40Ti-60W | 10 nm | 3050 | 17.4 |
| Example 14 | 35Ti-65W | 10 nm | 3010 | 16.5 |
| Example 15 | W | 10 nm | 3050 | 16.0 |
| Example 16 | Ta | 10 nm | 2950 | 15.9 |
| Example 17 | Mo | 10 nm | 2960 | 16.6 |
| Reference | no | — | 2690 | 12.8 |
| Example 1 | underlayer | | | |
| Reference | glass disk | 14 Gb/inch² | 3000 | 16.9 |
| Example 2 | | | | |

As it can be understood from the above Table 1, if the magnetic disc arrangement lacks the underlayer as in the Reference Example 1, both of the coercive force Hc and the S/N ratio stay in a level of very small value, as compared with Examples 1 to 9 and Examples 11 to 14, which are provided with an underlayer composed of Ti—W alloy. One of possible reasons the above phenomenon is brought about is that, if the Ru film is formed directly on the resin substrate, the c-axis of Ru underlayer is oriented normal to the film plane, with the result that in-plane orientation of the easy-axis of the magnetic film formed on the Ru film is affected.

If the underlayer 3 of the magnetic disc arrangement is composed of only Ti of the Ti—W alloy as in Example 10 listed in Table 1, the coercive force Hc and the S/N ratio also stay in a level of very small value as in the magnetic disc arrangement lacking the underlayer. This fact teaches us that if the underlayer is composed of only Ti, the c-axis of the Ru crystal of the intermediate layer cannot be in-plane oriented satisfactorily.

On the other hand, if the underlayer 3 of the magnetic disc arrangement is composed of only W of the Ti—W alloy as in Example 15 listed in Table 1, relatively satisfactory values were obtained in the coercive force Hc and the S/N ratio, as compared to Example 10 and Reference Example 1. However, the S/N ratio still stays in an unsatisfactory level as compared to the magnetic discs having the underlayer formed of Ti—W type alloy. Thus, it follows that the magnetic disc arrangement with the underlayer composed of only W cannot achieve a satisfactory performance in both of the coercive force Hc and the S/N ratio at a time.

Furthermore, analysis on Example 16 reveals that if the underlayer 3 is composed of only Ta, the resulting magnetic disc is inferior in the S/N ratio as compared with a magnetic disc having the underlayer formed of Ti—W type alloy. Also, the S/N ratio of Example 16 is unsatisfactory.

If the magnetic disc is arranged according to Example 17, i.e., the underlayer is composed of only Mo, the magnetic disc of this arrangement exhibits values of the coercive force Hc and the S/N ratio close to those of Reference Example 2 made of a glass disk. However, if the Ru intermediate layer tending to have relatively large internal stress is formed on the Mo film, then there is a fear that a minute crack is formed.

The graph of FIG. 5 illustrates a relationship between the thickness of the 50Ti-50W alloy underlayer 3 and the coercive force (Hc) thereof, and the graph of FIG. 6 illustrates a relationship between the thickness of the same 50Ti-50W alloy underlayer 3 and the S/N ratio thereof. Both of the graphs are plotted based on the data listed in Table 1. As it can be understood from the graphs, if the underlayer 3 is made to have a thickness falling in a range of from 5 nm to 25 nm, then the resulting magnetic disc tends to exhibit a coercive force of 2.37×10⁵ A/m (3000 Oe) or more and an S/N ratio of 17 dB or more. Thus, satisfactory magnetic characteristic and read/write characteristics can be obtained. These characteristics exceed those of glass disc equivalent to Reference Example 2 having a superficial recording density of 14 Gb/inch².

Also, the graph of FIG. 7 illustrates a relationship between the composition of tungsten contained in the underlayer 3 and the coercive force (Hc) thereof, and the graph of FIG. 8 illustrates a relationship between the composition of tungsten contained in the underlayer 3 and the S/N ratio thereof. Both of the graphs are also plotted based on the data listed in Table 1. The underlayer 3 made of Ti—W alloy was made to have a constant thickness of 10 nm and the composition of the Ti—W alloy was varied. As it can be understood from the result, if the amount of W added to the alloy falls within a range of from 25 atomic percent or more and 60 atomic percent or below, then the resulting magnetic disc tends to exhibit a coercive force (Hc) of 2.37×10⁵ A/m (3000 Oe) or more and an S/N ratio of 17 dB or more. Thus, satisfactory magnetic characteristic and read/write characteristics can be obtained. These characteristics exceed those of glass disc equivalent to Reference Example 2 having a superficial recording density of 14 Gb/inch².

The study and evaluation on the graphs of FIGS. 5, 6, 7 and 8 plotted based on the data of Table 1 leads to the following conclusion. That is, if the underlayer 3 was made composed of Ti—W alloy tending to exhibit satisfactory result as of the coercive force (Hc) and the S/N ratio, then the Ru intermediate layer 4 was oriented in the (100) direction and (101) direction, as was proved by the peaks of the X-ray diffraction pattern of FIG. 2. Owing to the orientation, the magnetic film 5 formed on the Ru intermediate layer 4 was improved in its in-plane orientation of the easy-axis.

FIG. 9 is a graph illustrating a relationship between the thickness of the ruthenium intermediate layer 4 and the coercive force (Hc) thereof, and FIG. 10 is a graph illustrating a relationship between the thickness of the ruthenium intermediate layer 4 and an S/N ratio thereof. Analysis on these graphs reveals that the resulting magnetic disc tends to exhibit a coercive force (Hc) of 2.37×10⁵ A/m (3000 Oe) or more when the Ru intermediate layer 4 had a thickness of 15 nm or more, and this relatively high coercive force was kept at the substantially constant level of 2.37×10⁵ A/m (3000 Oe) or more when the Ru intermediate layer 4 had a thickness of from 30 nm to 50 nm. Also, the resulting magnetic disc tends to exhibit a relatively high S/N ratio when the Ru intermediate layer 4 had a thickness of 15 nm or more, but the S/N ratio tends to be lowered 17 dB or below when the thickness of the Ru intermediate layer 4 exceeded 45 nm. The above study leads to the following conclusion. That is, it is desirable for the intermediate layer 4 made of Ru to have a thickness ranging from 15 nm to 45 nm.

### Example 19

Example 19 was fabricated by forming films under conditions shown in Table 2 and the resulting magnetic disc was subjected to a test of magnetic characteristic, read/write characteristics, and environmental test.

TABLE 2

| | | | | | 62Co- | |
|---|---|---|---|---|---|---|
| | | | | | 17.5Pt- | |
| | RF | | | | 8.5Cr- | |
| | Glow | 84Cr-16W | 50Ti-50W | Ru | 12SiO₂ | C |
| Pressure | 13.3 | 2.7 | 0.8 | 10.0 | 1.1 | 1.1 |
| (Pa) | | | | | | |
| Supplied | 200.0 | 50.0 | 150.0 | 180.0 | 180.0 | 1200.0 |
| electric | | | | | | |
| power | | | | | | |
| (W) | | | | | | |
| Time | 8.0 | 6.7 | 11.1 | 20.2 | 11.1 | 5.3 |
| (Sec) | | | | | | |
| Film | | 1.0 | 10.0 | 20.0 | 11.0 | 6.0 |
| thickness | | | | | | |
| (nm) | | | | | | |

A plastic substrate made of polycycloolefin (ZEONEX, provided by Nippon Zeon) was prepared and this substrate was subjected to RF Glow process and film forming processes with materials of 84Cr-16W, 50Ti-50W, Ru, 62Co-17.5Pt-8.5Cr-12SiO₂, and C in this order. The obtained magnetic disc was placed under measurement of magnetic characteristic with a VSM (Vibrating Sample Magnetometer). Thus, data of Mr·t=0.4 mA, Hc=255 kA/m, and S*=0.85 (where S* represents coercive force square ratio) were obtained. The magnetic disc was also placed under measurement of read/write characteristics with a spin stand of LS-90 using an R/W Analyzer Guzik 1632A (Kyodo Denshi-sha). The head utilized for the measurement was a GMR nano-slider having a recording track width of 0.5 μm, a writing track width of 0.25 μm, and a floating gap of 25 nm. The S/N ratio of the magnetic disc was measured at a measuring diameter of 28.7 mm, a rotating speed of 5400 rpm and a recording density of 250 kFCL. As a result, 27 dB was obtained as an absolute value of the S/N ratio. This magnetic recording medium was also placed under measurement of an SEM (Scanning Electron Microscope). As a result, it was confirmed that no crack was found in the magnetic recording medium. Further, this magnetic recording medium was placed under a Clean environment of Class 100 or below at a temperature of 80° C. and a humidity of 80% for four hours. Thereafter, the temperature of the atmosphere surrounding the magnetic recording medium was gradually lowered to −40° C. for one hour, the magnetic recording medium was left at the environment for one hour, and then the temperature of the atmosphere was gradually raised up to a room temperature for four hours. Thereafter, it was inspected whether film floating was brought about or not. As a result, it was confirmed that there was no film floating brought about. The disc as the magnetic recording medium was placed on the aforesaid spin stand LS-90 to confirm whether the disc was deformed or not, by using the aforesaid head. It was confirmed that the disc provided the read/write characteristics without crush.

While a typical embodiment of the magnetic recording medium and several Examples based on the embodiment have been described above together with a lot of experimental data, it should be understood to those skilled in the art that the present invention is not limited to the embodiment and examples described herein, but various changes, modifications, variations, combinations and sub-combinations can be practiced without departing from the scope and gist of the present invention.

What is claimed is:

1. An in-plane magnetic recording medium comprising a substrate made of resin, said substrate having successively provided thereon at least an underlayer made of an alloy of titanium (Ti) and tungsten (W), an intermediate layer having a hexagonal close-packed structure, a magnetic film mainly composed of cobalt (Co), a protecting film and a lubricant coat.

2. The in-plane magnetic recording medium according to claim 1, wherein said underlayer comprises an alloy of titanium (Ti) and tungsten (W), the titanium containing tungsten in a range of 25 atomic percent or more to 60 atomic percent or less.

3. The in-plane magnetic recording medium according to claim 1, wherein said underlayer has a thickness between 5 nm or more and 25 nm or less.

4. The in-plane magnetic recording medium according to claim 1, wherein said intermediate layer is made of ruthenium (Ru).

5. The in-plane magnetic recording medium according to claim 1, wherein said intermediate layer has a thickness between 15 nm or more and 45 nm or less.
